(19) United States
(12) Patent Application Publication
(10) Pub. No.: US 2022/0365180 A1
(43) Pub. Date: Nov. 17, 2022

(54) LIDAR SYSTEM WITH SENSITIVITY ADJUSTMENT

(71) Applicant: Continental Automotive Systems, Inc., Auburn Hills, MI (US)

(72) Inventor: Horst Wagner, Goleta, CA (US)

(73) Assignee: Continental Automotive Systems, Inc., Auburn Hills, MI (US)

(21) Appl. No.: 17/302,802

(22) Filed: May 12, 2021

(51) Int. Cl. G01S 7/4865; G01S 7/481; G01S 17/10; G01S 17/89; G01S 17/931

(52) U.S. Cl. CPC G01S 7/4865; G01S 7/4816; G01S 17/10; G01S 17/89; G01S 17/931; G01S 7/4814

(57) ABSTRACT

A lidar system includes a light emitter and an array of pixels. Each pixel includes at least one photodetector. A controller is configured to actuate the light emitter to output shots of light and provide a bias voltage to the pixels. The controller updates time-resolved histograms for the shots based on detected light. The controller identifies that the counts in one of the bins of the histogram for one pixel exceed a predetermined level and, for subsequent shots, reduce the sensitivity of that pixel during the time range associated with the one bin of the histogram for that pixel to be lower than the sensitivity of that pixel at other time ranges. This provides a different detection sensitivity on a pixel-by-pixel basis for increased resolution for near objects and increased probability of detection of far objects.

### BACKGROUND

A lidar system includes a photodetector, or an array of photodetectors. Light is emitted into a field of view of the photodetector. The photodetector detects light that is reflected by an object in the field of view. For example, a flash lidar system emits pulses of light, e.g., laser light, into essentially the entire the field of view. The detection of reflected light is used to generate a 3D environmental map of the surrounding environment. The time of flight of the reflected photon detected by the photodetector is used to determine the distance of the object that reflected the light.

The lidar system may be mounted on a vehicle to detect objects in the environment surrounding the vehicle and to detect distances of those objects for environmental mapping. The output of the lidar system may be used, for example, to autonomously or semi-autonomously control operation of the vehicle, e.g., propulsion, braking, steering, etc. Specifically, the system may be a component of or in communication with an advanced driver-assistance system (ADAS) of the vehicle.

Some applications, e.g., in a vehicle, include several lidar systems. For example, the multiple system may be aimed in different directions and/or may detect light at different distance ranges, e.g., a short range and a long range.

### BRIEF DESCRIPTION OF THE DRAWINGS

FIG. 1 is a perspective view of a vehicle having a lidar system.

FIG. 2 is a perspective view of the lidar system.

FIG. 3 is a cross section of the lidar system.

FIG. 4 is a perspective view of components of a light-receiving system of the lidar system.

FIG. 4A is an enlarged illustration of a portion of FIG. 4.

FIG. 5 is a block diagram of components of the vehicle and the lidar system.

FIG. 6 is an illustration for an example prior art lidar system showing an optical return signal during time of flight of emitted light and an accompanying histogram showing light detection by a pixel of the lidar system.

FIG. 7A is an illustration of an example of applied sensitivity over time and an empty histogram for a pixel before any shots are emitted by a light emitter of the lidar system.

FIG. 7B is an illustration of an example of applied sensitivity over time and a histogram for the pixel after a first series of shots.

FIG. 7C is an illustration of an example of applied sensitivity over time and a histogram for the pixel after a second series of shots.

FIG. 7D is an illustration of an example of applied sensitivity over time and a histogram for the pixel after a third series of shots.

FIG. 8 is an example circuit of the lidar system.

FIG. 9 is a flow chart illustrating a process for controlling the lidar system.

### DETAILED DESCRIPTION

With reference to the Figures, wherein like numerals indicate like parts, a lidar system 20 is shown. The lidar system 20 includes a light emitter 22 and an array of pixels 38. Each pixel 38 includes at least one photodetector 24. The lidar system 20 includes a controller 26 configured to actuate the light emitter 22 to output shots of light. The controller 26 is configured to provide a bias voltage to the pixels 38. The lidar system 20 updates time-resolved histograms for the pixels, the histograms having bins associated with time ranges of light detection. Specifically, the controller 26 is configured to update histograms for the pixels 38 based on light detected by the pixels 38. The controller 26 is configured to identify that the counts in one bin of the histogram for one pixel 38 exceed a predetermined level. The controller 26 is configured to, for subsequent shots, reduce the sensitivity of the one pixel 38 during the time range associated with the one bin of the histogram for the one pixel 38 to be lower than the sensitivity of the one pixel 38 at other time ranges. Specifically, this reduction of the sensitivity of the one pixel 38 is in response to the identification that the counts in the one bin of the histogram for the one pixel 38 exceeds a predetermined level.

By applying a different sensitivity to one of the pixels 38 for a time range associated with a bin that exceeds a predetermined level for earlier shots, the lidar system 20 to has a different detection sensitivity on a pixel-by-pixel basis for different shots. Varying the sensitivity on a pixel-by-pixel basis reduces negative impact of dead time in which the pixels 38 have inhibited detection abilities (such as during quenching a SPAD, as further described below). Specifically, for a pixel 38 with a bin that exceeds a predetermined, the sensitivity is reduced for the subsequent shots for that pixel 38 at the time range associated with that bin to reduce the probability of detecting a photon during that time range and thus reduce the occurrence of dead time after that time range. This results in increased resolution and/or accuracy when detecting near objects with strong signal returns while providing a relatively higher sensitivity at other times for increased probability of detection of far objects. This allows the lidar system 20 to detect objects at various distances and/or various return intensities without changing the light intensity of the shots.

As an example, the sensitivity may remain constant across all of the shots for all pixels 38 that do not have a bin that exceeds a predetermined level. In addition, for the one or more pixels 38 that have a bin that exceeds a predetermined level, the sensitivity may remain constant across all of the shots (at the same sensitivity as for the pixels 38 that do not have a bin that exceeds a predetermined level) except for the time range associated with the bin that exceeds a predetermined level. This control of the sensitivity at specific time ranges on a pixel-by-pixel basis provides increased resolution and/or accuracy when detecting near objects while providing a relatively higher sensitivity at other times for increased probability of detection far objects.

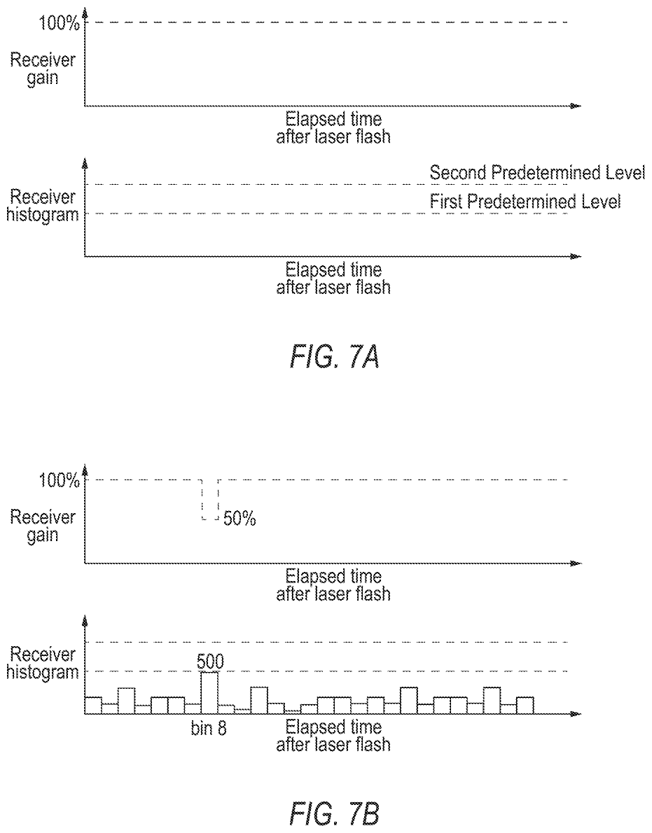

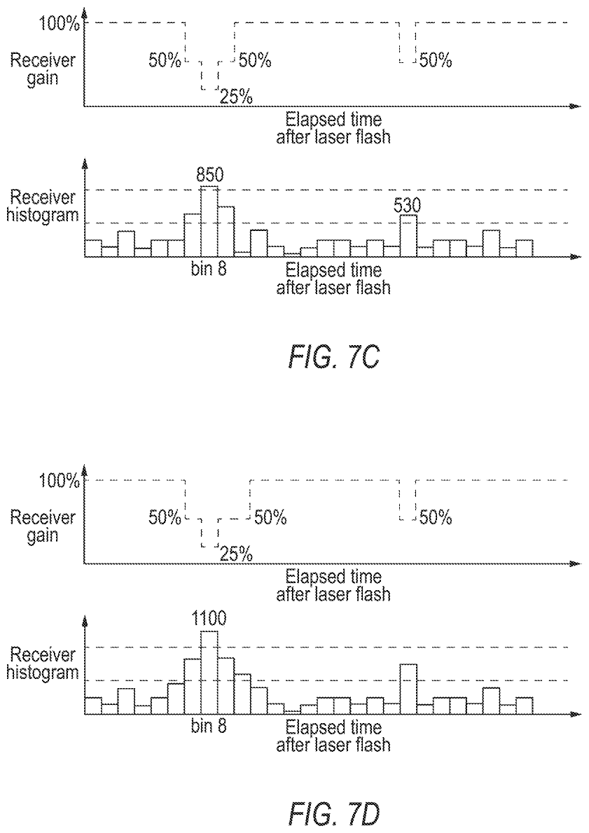

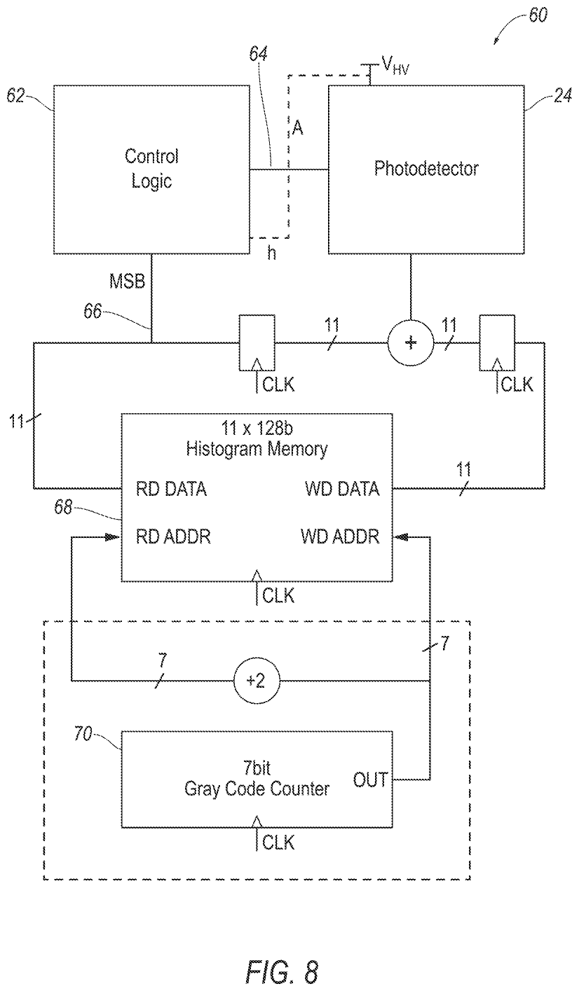

An example of the operation of the lidar system 20 is shown in FIGS. 7A-7D, which is shown merely as one example to illustrate the operation of the lidar system 20. FIGS. 7A-7D each have a graph showing the sensitivity applied to one pixel 38 over time and a time-resolved histogram. In the time-resolved histogram, the bins from left to right are successive time ranges. A count is added to the bin for each occurrence of light detection and the histogram is cumulative for all of the shots. FIG. 7A shows the sensitivity at a constant level over time for the first of the shots. FIGS. 7B-7D are after additional shots; by way of example, after 500 shots in FIG. 7B, 1000 shots in FIG. 7C, and 2000 shots in FIG. 7D. In FIG. 7B, after 500 shots, the count in bin 8 exceeds a predetermined level and, in response, the lidar system 20 identifies that the sensitivity for that pixel 38 at the time range associated with bin 8 will be reduced for subsequent shots (e.g., the gain is reduced to 50% of the gain for the first of the shots). In FIG. 7C, after 1000 shots, the counts in bin 8 exceed a second predetermined level and the counts in bins 7, 9, and 20 exceed a predetermined level (which, by way of example, is the same as the predetermined level in FIG. 7B). In response, the lidar system 20 identifies that the sensitivity for that pixel 38 at the time range associated with bin 8 will be further reduced for subsequent shots (e.g., the gain is reduced to 25% of the gain for the first of the shots), and the sensitivity for that pixel 38 for the time ranges associated with bin 7, bin 9, and bin 20 will be reduced for subsequent shots (e.g., the gain is reduced to 50% of the gain for the first of the shots). In FIG. 7D, after 2000 shots, the sensitivity at the time range associated with bin 8 remains at the further reduced sensitivity (e.g., at 25% gain) as after 1000 shots in FIG. 7C, and the sensitivity at the time ranges associated with bins 7, 9, 10, and 20 is reduced (e.g., at 50% gain). FIG. 8, as described further below, shows an example of a circuit that can perform the operation shown in FIGS. 7A-7D.

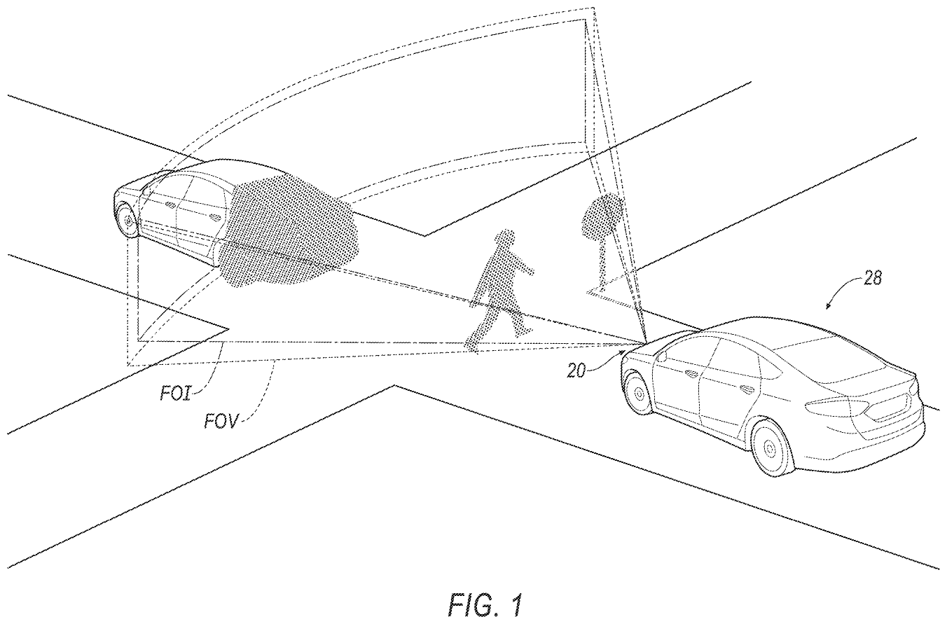

FIG. 1 shows an example vehicle 28. The lidar system 20 is mounted to the vehicle 28. In such an example, the lidar system 20 is operated to detect objects in the environment surrounding the vehicle 28 and to detect distances of those objects for environmental mapping. The output of the lidar system 20 may be used, for example, to autonomously or semi-autonomously control the operation of the vehicle 28, e.g., propulsion, braking, steering, etc. Specifically, the lidar system 20 may be a component of or in communication with an advanced driver-assistance system (ADAS) 30 of the vehicle 28. The lidar system 20 may be mounted on the vehicle 28 in any suitable position and aimed in any suitable direction. As one example, the lidar system 20 is shown on the front of the vehicle 28 and directed forward. The vehicle 28 may have more than one lidar system 20 and/or the vehicle 28 may include other object detection systems, including other lidar systems 20. The vehicle 28 is shown in FIG. 1 as including a single lidar system 20 aimed in a forward direction merely as an example. The vehicle 28 shown in the Figures is a passenger automobile. As other examples, the vehicle 28 may be of any suitable manned or un-manned type including a plane, satellite, drone, watercraft, etc.

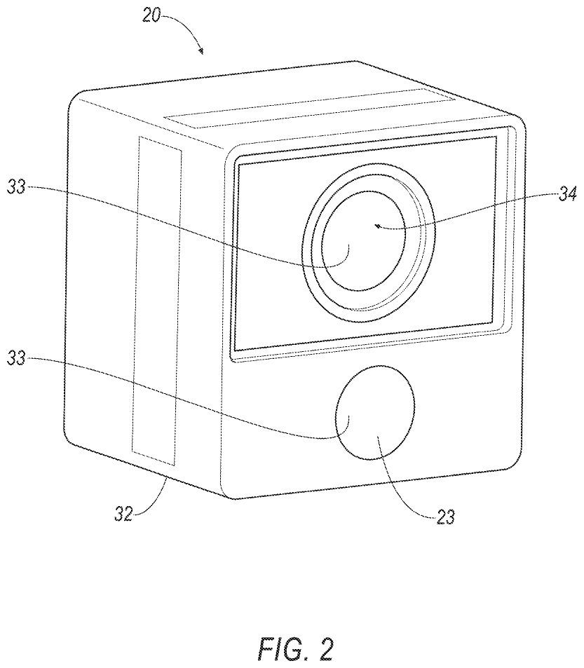

The lidar system 20 may be a solid-state lidar system 20. In such an example, the lidar system 20 is stationary relative to the vehicle 28. For example, the lidar system 20 may include a casing 32 (shown in FIG. 2 and described below) that is fixed relative to the vehicle 28, i.e., does not move relative to the component of the vehicle 28 to which the casing 32 is attached, and a silicon substrate of the lidar system 20 is supported by the casing 32.

As a solid-state lidar system, the lidar system 20 may be a flash lidar system. In such an example, the lidar system 20 emits pulses of light into the field of illumination FOI (FIG. 1). More specifically, the lidar system 20 may be a 3D flash lidar system 20 that generates a 3D environmental map of the surrounding environment, as shown in part in FIG. 1. An example of a compilation of the data into a 3D environmental map is shown in the FOV and the field of illumination (FOI) in FIG. 1. A 3D environmental map may include location coordinates of points within the FOV with respect to a coordinate system, e.g., a Cartesian coordinate system with an origin at a predetermined location such as a GPS (Global Positioning System) reference location, or a reference point within the vehicle 28, e.g., a point where a longitudinal axis and a lateral axis of the vehicle 28 intersect.

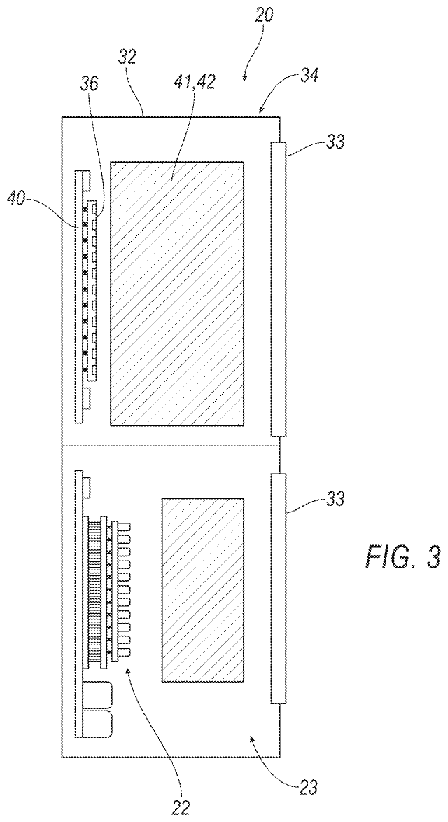

In such an example, the lidar system 20 is a unit. With reference to FIGS. 2 and 3, the lidar system 20 may include the casing 32, an outer optical window 33, a light receiving system 34, and a light emitting system 23. The light receiving system may include a focal-plane array (FPA) 36.

The casing 32, for example, may be plastic or metal and may protect the other components of the lidar system 20 from environmental precipitation, dust, etc. In the alternative to the lidar system 20 being a unit, components of the lidar system 20, e.g., the light emitting system 23 and the light receiving system 34, may be separate and disposed at different locations of the vehicle 28. The lidar system 20 may include mechanical attachment features to attach the casing 32 to the vehicle 28 and may include electronic connections to connect to and communicate with electronic system of the vehicle 28, e.g., components of the ADAS.

The outer optical window 33 allows light to pass through, e.g., light generated by the light emitting system 23 exits the lidar system 20 and/or light from environment enters the lidar system 20. The outer optical window 33 protects an interior of the lidar system 20 from environmental conditions such as dust, dirt, water, etc. The outer optical window 33 is typically formed of a transparent or semi-transparent material, e.g., glass, plastic. The outer optical window 33 may extend from the casing 32 and/or may be attached to the casing 32.

With reference to FIGS. 1-3, the lidar system 20 includes the light emitter 22 that emits shots, i.e., pulses, of light into the field of illumination FOI for detection by a light-receiving system 34 when the light is reflected by an object in the field of view FOV. The light-receiving system 34 has a field of view (hereinafter “FOV”) that overlaps the field of illumination FOI and receives light reflected by surfaces of objects, buildings, road, etc., in the FOV. The light emitter 22 may be in electrical communication with the controller 26, e.g., to provide the shots in response to commands from the controller 26.

With reference to FIG. 3, the light emitting system 23 may include one or more light emitter 22 and optical components such as a lens package 41, lens crystal 42, pump delivery optics, etc. The optical components, e.g., lens package 41, lens crystal 42, etc., may be between the light emitter 22 on a back end of the casing 32 and the outer optical window 33 on a front end of the casing 32. Thus, light emitted from the light emitter 22 passes through the optical components before exiting the casing 32 through the outer optical window 33.

The light emitter 22 may be a semiconductor light emitter, e.g., laser diodes. In one example, as shown in FIG. 3, the light emitter 22 may include a vertical-cavity surface-emitting laser (VCSEL) emitter. As another example, the light emitter 22 may include a diode-pumped solid-state laser (DPSSL) emitter. As another example, the light emitter 22 may include an edge emitting laser emitter. The light emitter 22 may be designed to emit a pulsed flash of light, e.g., a pulsed laser light. Specifically, the light emitter 22, e.g., the VCSEL or DPSSL or edge emitter, is designed to emit a pulsed laser light. Each pulsed flash of light may be referred to as the “shot” as used herein. The light emitted by the light emitter 22 may be infrared light. Alternatively, the light emitted by the light emitter 22 may be of any suitable wavelength. The lidar system 20 may include any suitable number of light emitters 22. In examples that include more than one light emitter 22, the light emitters 22 may be identical or different.

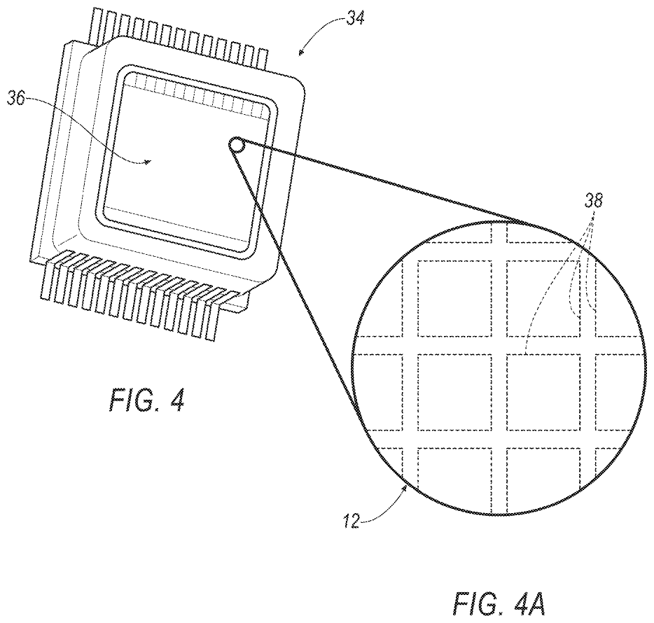

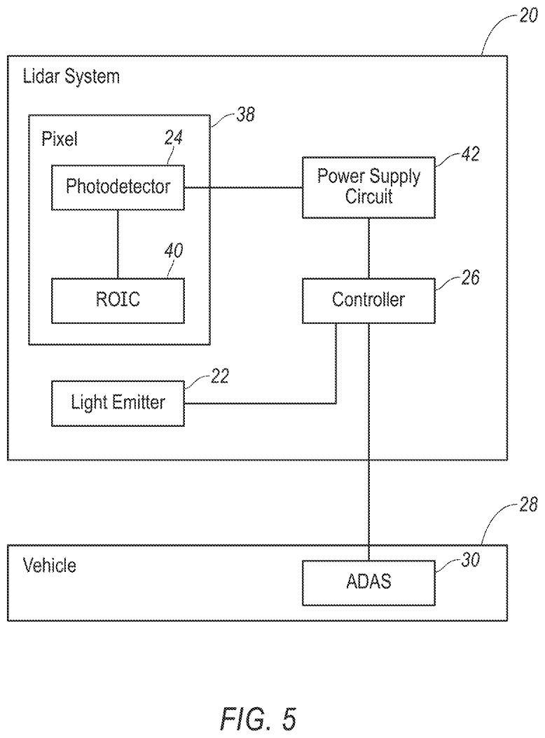

With reference to FIGS. 3 and 4, the light-receiving system 34 detects light, e.g., emitted by the light emitter 22. The light-receiving system 34 may include a focal-plane array (FPA) 36. The FPA 36 can include an array of pixels 38. Each pixel 38 can include at least one of photodetectors 24 and a read-out circuit (ROIC) 40. A power-supply circuit (not numbered) may power the pixels 38. The FPA 36 may include a single power-supply circuit in communication with all photodetectors 24 or may include a plurality of power-supply circuits in communication with a group of the photodetectors 24. The light-receiving system 34 may include receiving optics such as the lens package. The light-receiving system 34 may include an outer optical window and the receiving optics may be between the receiving outer optical window and the FPA 36. The pixel 38 reads to a histogram. The pixel 38 can include one photodetector 24 that reads to a histogram or a plurality of photodetectors 24 that each read to the same histogram. In the event the pixel 38 includes multiple photodetectors 24, the photodetectors 24 may share chip architecture.

The FPA 36 detects photons by photo-excitation of electric carriers, e.g., with the photodetectors 24. An output from the FPA 36 indicates a detection of light and may be proportional to the amount of detected light. The outputs of FPA 36 are collected to generate a 3D environmental map, e.g., 3D location coordinates of objects and surfaces within FOV of the lidar system 20. The FPA 36 may include the photodetectors 24, e.g., that include semiconductor components for detecting laser and/or infrared reflections from the FOV of the lidar system 20. The photodetectors 24, may be, e.g., photodiodes (i.e., a semiconductor device having a p-n junction or a p-i-n junction) including avalanche photodetectors, metal-semiconductor-metal photodetectors, phototransistors, photoconductive detectors, phototubes, photomultipliers, etc. Optical elements such as a lens package of the light-receiving system 34 may be positioned between the FPA 36 in the back end of the casing 32 and the outer optical window on the front end of the casing 32.

The ROIC 40 converts an electrical signal received from photodetectors 24 of the FPA 36 to digital signals. The ROIC 40 may include electrical components which can convert electrical voltage to digital data. The ROIC 40 may be connected to the controller 26, which receives the data from the ROIC 40 and may generate 3D environmental map based on the data received from the ROIC 40. The ROIC may be integrated jointly with the FPA and/or the controller 26 into one single integrated circuit or component.

Each pixel 38 may include one photodetector 24, e.g., an avalanche-type photodetector (as described further below), connected to the power-supply circuits. Each power-supply circuit may be connected to one of the ROICs 40. Said differently, each power-supply circuit may be dedicated to one of the pixels 38 and each read-out circuit 40 may be dedicated to one of the pixels 38. Each pixel 38 may include more than one photodetector 24 (for example, two avalanche-type photodetectors).

The pixel 38 functions to output a single signal or stream of signals corresponding to a count of photons incident on the pixel 38 within one or more sampling periods. Each sampling period may be picoseconds, nanoseconds, microseconds, or milliseconds in duration. The pixel 38 can output a count of incident photons, a time between incident photons, a time of incident photons (e.g., relative to an illumination output time), or other relevant data, and the lidar system 20 can transform these data into distances from the system to external surfaces in the fields of view of these pixels 38. By merging these distances with the position of pixels 38 at which these data originated and relative positions of these pixels 38 at a time that these data were collected, the controller 26 (or other device accessing these data) can reconstruct a three-dimensional 3D (virtual or mathematical) model of a space within FOV, such as in the form of 3D image represented by a rectangular matrix of range values, wherein each range value in the matrix corresponds to a polar coordinate in 3D space.

The pixels 38 may be arranged as an array, e.g., a 2-dimensional (2D) or a 1-dimensional (1D) arrangement of components. A 2D array of pixels 38 includes a plurality of pixels 38 arranged in columns and rows.

The photodetector 24 may be an avalanche-type photodetector. In other words, the photodetector 24 may be operable as a single-photon avalanche diode (SPAD) based on the bias voltage applied to the photodetector 24. To function as the SPAD, the photodetector 24 operates at a bias voltage above the breakdown voltage of the semiconductor, i.e., in Geiger mode. Accordingly, a single photon can trigger a self-sustaining avalanche with the leading edge of the avalanche indicating the arrival time of the detected photon. In other words, the SPAD is a triggering device.

The power-supply circuit supplies power to the photodetector 24. The power-supply circuit may include active electrical components such as MOSFET (Metal-Oxide-Semiconductor Field-Effect Transistor), BiCMOS (Bipolar CMOS), etc., and passive components such as resistors, capacitors, etc. The power-supply control circuit may include electrical components such as a transistor, logical components, etc. The power-supply control circuit may control the power-supply circuit, e.g., in response to a command from the controller 26, to apply bias voltage (and quench and reset the photodetectors 24 in the event the photodetector 24 is operated as a SPAD).

Data output from the ROIC 40 may be stored in memory, e.g., for processing by the controller 26. The memory may be DRAM (Dynamic Random Access Memory), SRAM (Static Random Access Memory), and/or MRAM (Magneto-resistive Random Access Memory) electrically connected to the ROIC 40.

As set forth above, in examples in which the photodetector 24 operates as a SPAD, the SPAD operates in Geiger mode. “Geiger mode” means that the SPAD is operated above the breakdown voltage of the semiconductor and a single electron-hole pair (generated by absorption of one photon) can trigger a strong avalanche. The SPAD may be biased above its breakdown voltage to produce an average internal gain on the order of one million (in this context, “gain” is a measure of an ability of a two-port circuit, e.g., the SPAD, to increase power or amplitude of a signal from the input to the output port). Under such conditions, a readily-detectable avalanche current can be produced in response to a single input photon, thereby allowing the SPAD to be utilized to detect individual photons. “Avalanche breakdown” is a phenomenon that can occur in both insulating and semiconducting materials. It is a form of electric current multiplication that can allow very large currents within materials which are otherwise good insulators.

When the SPAD is triggered in a Geiger-mode in response to a single input photon, the avalanche current continues as long as the bias voltage remains above the breakdown voltage of the SPAD. Thus, in order to detect the next photon, the avalanche current must be “quenched” and the SPAD must be reset. Quenching the avalanche current and resetting the SPAD involves a two-step process: (i) the bias voltage is reduced below the SPAD breakdown voltage to quench the avalanche current as rapidly as possible, and (ii) the SPAD bias is then raised by the power-supply circuit to a voltage above the SPAD breakdown voltage so that the next photon can be detected.

Active quenching is performed by sensing a leading edge of the avalanche current, generating a standard output pulse synchronous with the avalanche build-up, quenching the avalanche by lowering the bias down to the breakdown voltage and resetting the SPAD to the operative level.

Quenching may be passive or active quenching. A passive quenching circuit typically includes a single resistor in series with the SPAD. The avalanche current self-quenches because it develops a voltage drop across a resistor, e.g., 100 kΩ (Kilo Ohm) or more. After the quenching of the avalanche current, the SPAD bias voltage recovers and therefore will be ready to detect the next photon. An active circuit element can be used for resetting while performing a passive quench active reset (PQAR).

In an active quenching, upon measuring an onset of the avalanche current across a resistor, e.g., 50Ω, a digital output pulse, synchronous with the photon arrival time is generated. The quenching circuit then quickly reduces the bias voltage to below breakdown voltage, then returns bias voltage to above the breakdown voltage ready to sense the next photon. This mode is called active quench active reset (AQAR), however, depending on circuit requirements, active quenching passive reset (AQPR) may be provided. AQAR circuit typically allows lower dead times (times in which a photon cannot be detected) and reduces dead time compare to circuits having passive quenching and/or passive resetting.

Light emitted by the light emitter 22 may be reflected off an object back to the lidar system 20 and detected by the photodetectors 24. An optical signal strength of the returning light may be, at least in part, proportional to a time of flight/distance between the lidar system 20 and the object reflecting the light. The optical signal strength may be, for example, an amount of photons that are reflected back to the lidar system 20 from one of the shots of pulsed light. The greater the distance to the object reflecting the light/the greater the flight time of the light, the lower the strength of the optical return signal, e.g., for shots of pulsed light emitted at a common intensity. As described above, the lidar system 20 generates a histogram for each pixel 38 based on detection of returned shots. The histogram may be used to generate the 3D environmental map. As set forth above, the pixel 38 reads to a histogram. The pixel 38 can include one photodetector 24 that reads to a histogram or a plurality of photodetectors 24 that each read to the same histogram. In the event the pixel 38 includes multiple photodetectors 24, the photodetectors 24 may share chip architecture. Each bin of the histogram is associated with a time range of light detection. For each shot emitted from the light emitter 22 of the lidar system 20, a count is added at a bin associated with the time range at which light is detected by the pixel 38. A count is added to the bin for each occurrence of light detection and the histogram is cumulative for all of the shots. Example histograms for the lidar system 20 are shown in FIGS. 7A-7D.

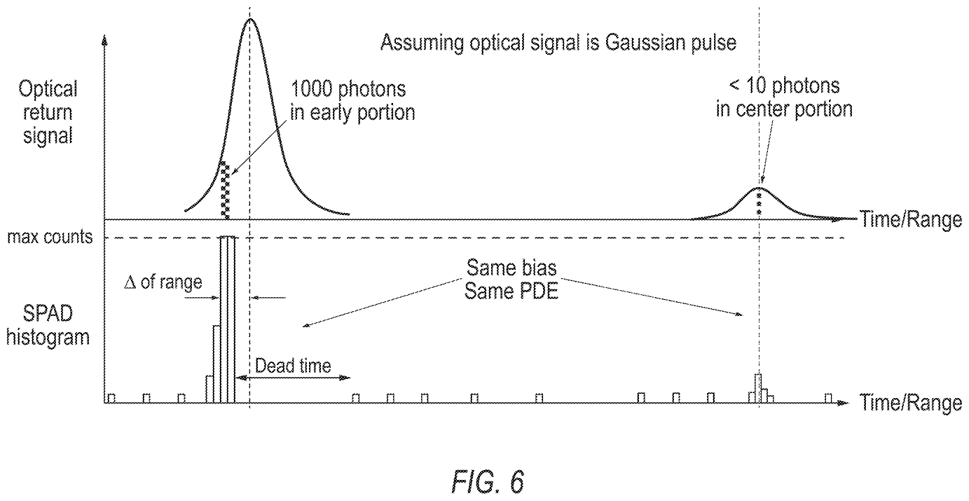

With reference to FIG. 6 for a prior art lidar system, a graph of the strength of the optical return signal with respect to the distance to the object reflecting the light/the flight time of the light is illustrated. For the top graph in FIG. 6, increased height from a horizontal axis indicates increased optical signal strength, and increased distance to the right of a vertical axis indicates increased distance to the object reflecting the light/increased flight time of the light. For example, the first peak indicates light that is reflected off a relatively close object that returns with a relatively high optical signal strength. As another example, the second peak indicates light that is reflected off a relatively far object that returns with a relatively low optical signal strength. The reflected light indicated by the peaks may be from a single shot of light emitted by the lidar system 20 or from multiple shots of pulsed of light from the lidar system 20. With continued reference to the prior art example in FIG. 6, the histogram reflects a poor representation of the first peak of optical return for a near object. This is due to dead time for the pixel, e.g., associated with quenching of the SPAD. At the second peak of optical return for the far object, the probability of detecting the object is reduced due to insufficient gain. The controller 26 may be configured to perform operations specified herein. The controller 26 may include a programmable processor and/or a dedicated electronic circuit including an Application-Specific Integrated Circuit (ASIC) that is manufactured for a particular operation, e.g., an ASIC for determining gain control signal. In another example, a dedicated electronic circuit may include a Field-Programmable Gate Array (FPGA) which is an integrated circuit manufactured to be configurable by a customer. Typically, a hardware description language such as VHDL (Very High Speed Integrated Circuit Hardware Description Language) is used in electronic design automation to describe digital and mixed-signal systems such as FPGA and ASIC. For example, an ASIC is manufactured based on VHDL programming provided pre-manufacturing, whereas logical components inside an FPGA may be configured based on VHDL programming, e.g. stored in a memory electrically connected to the FPGA circuit. In some examples, a combination of processor(s), ASIC(s), and/or FPGA circuits may be included inside a chip packaging.

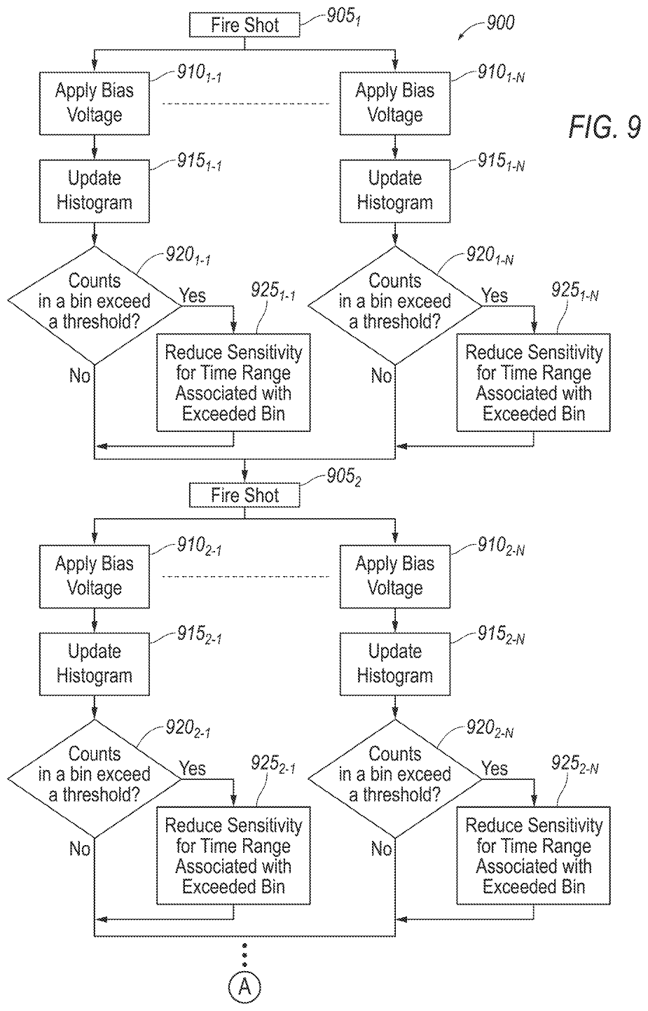

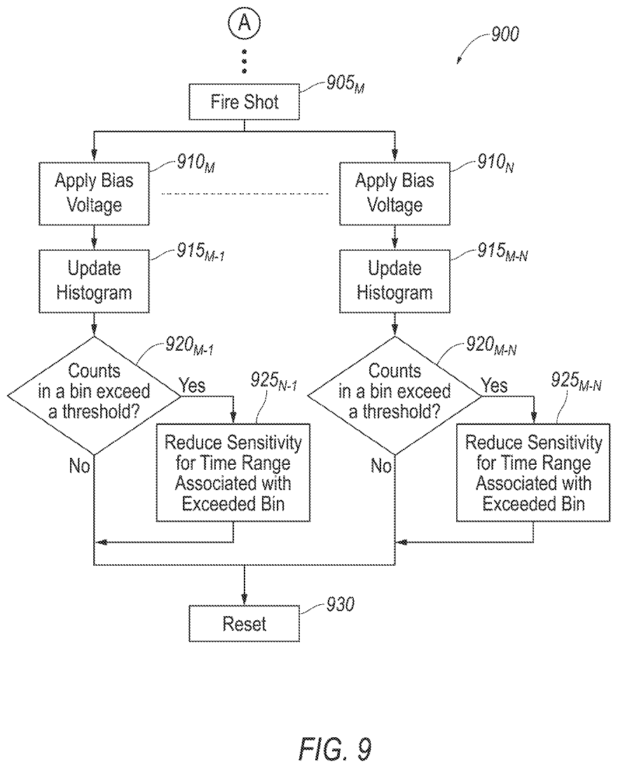

The controller 26 of the lidar system 20 may be a microprocessor-based controller implemented via circuits, chips, or other electronic components. The controller 26 is in electronic communication with the pixels 38 (e.g., with the ROIC 40 and power-supply circuits) and the vehicle 28 (e.g., with the ADAS 30) to receive data and transmit commands. The controller 26 may include a processor and a memory. The controller 26 may be configured to execute operations disclosed herein. Specifically, the memory stores instructions executable by the processor to execute the operations disclosed herein and electronically stores data and/or databases. electronically storing data and/or databases. The memory includes one or more forms of computer-readable media, and stores instructions executable by the controller 26 for performing various operations, including as disclosed herein, for example the method 900 shown in FIG. 9. For example, the controller 26 may include a dedicated electronic circuit including an ASIC (Application Specific Integrated Circuit) that is manufactured for a particular operation, e.g., calculating a histogram of data received from the lidar system 20 and/or generating a 3D environmental map for a Field of View (FOV) of the vehicle 28. In another example, the controller 26 may include an FPGA (Field Programmable Gate Array) which is an integrated circuit manufactured to be configurable by a customer. As an example, a hardware description language such as VHDL (Very High Speed Integrated Circuit Hardware Description Language) is used in electronic design automation to describe digital and mixed-signal systems such as FPGA and ASIC. For example, an ASIC is manufactured based on VHDL programming provided pre-manufacturing, and logical components inside an FPGA may be configured based on VHDL programming, e.g. stored in a memory electrically connected to the FPGA circuit. In some examples, a combination of processor(s), ASIC(s), and/or FPGA circuits may be included inside a chip packaging. The controller 26 may be a set of computers communicating with one another via the communication network of the vehicle 28, e.g., a computer in the lidar system 20 and a second computer in another location in the vehicle 28.

The vehicle may include a computer that operates the vehicle 28 in an autonomous, a semi-autonomous mode, or a non-autonomous (or manual) mode. For purposes of this disclosure, an autonomous mode is defined as one in which each of vehicle propulsion, braking, and steering are controlled by the computer; in a semi-autonomous mode the computer controls one or two of vehicle propulsion, braking, and steering; in a non-autonomous mode a human operator controls each of vehicle propulsion, braking, and steering.

The computer may be programmed to, based on input from the lidar system 20, operate one or more of vehicle brakes, propulsion (e.g., control of acceleration in the vehicle by controlling one or more of an internal combustion engine, electric motor, hybrid engine, etc.), steering, climate control, interior and/or exterior lights, etc., as well as to determine whether and when the computer, as opposed to a human operator, is to control such operations. Additionally, the computer may be programmed to determine whether and when a human operator is to control such operations.

The controller 26 may include or be communicatively coupled to, e.g., via a vehicle 28 communication bus, more than one processor, e.g., controllers or the like included in the vehicle for monitoring and/or controlling various vehicle controllers, e.g., a powertrain controller, a brake controller, a steering controller, etc. The controller 26 is generally arranged for communications on a vehicle communication network that can include a bus in the vehicle such as a controller area network (CAN) or the like, and/or other wired and/or wireless mechanisms.

The controller 26 is configured, e.g., programmed, to instruct the light emitter 22 to emit shots, as shown in blocks 905. As shown in FIG. 9 and as set forth above, the example histograms in FIGS. 7B, 7C, and 7D are after 500 shots, 1000 shots, and 2000 shots, respectively. The controller 26 may operate one or more of the pixels 38 differently for subsequent shots, as described further below.

The controller 26 may actuate the light emitter 22 by transmitting a command to the light emitter 22 specifying such actuation. Each shot may by temporally spaced from the next by a specified amount of time. The amount of time may be predetermined and stored in memory, e.g., based on the sampling period of the photodetectors 24, the capabilities of the light emitter 22, etc. In FIG. 9, a shot is shown at 905₁, a subsequent shot is shown at 905₂, and a final shot is shown at 905_{N}. The ellipses before 905_{N} indicate intermediate groups of repeating blocks 905-925. As an example, the controller may be configured, e.g., programmed, to output several thousand shots between blocks 905₁ and 930. Each shot may have the same light intensity level and the same wavelength or, as another example, the different shots may have different light intensity level and/or wavelength.

The controller 26 is configured, e.g., programmed, to provide a bias voltage to the pixels 38 for each shot, as shown in blocks 910 in FIG. 9. In FIG. 9, the subscripts after 910 indicate the shot number and the pixel number. For example, 910₁₋₁ is the application of the bias voltage to a first pixel for a first shot. The controller 26 is configured, e.g., programmed, to provide bias voltages to the photodetectors 24 of the array of photodetectors 24. The controller 26 may provide the bias voltages by sending a command to the power supply circuit, e.g., specifying the bias voltage. Specifically, with reference to blocks 910, the controller 26 provides the bias voltage to the photodetectors 24 just prior to, concurrently with the initiation of the shot. The controller 26 provides the bias voltage such that a photon returned from the shot is detected while that bias voltage is applied. For example, for a shot, the controller 26 applies the bias voltage at a suitable time to ensure that the photodetectors 24 are biased with the bias voltage when a photon is returned from that shot. The initial application of that bias voltage is just prior to or concurrent with the initiation of the shot and the application of the bias voltage continues during and after the emission of the shot. Similarly, for a subsequent shot, the controller 26 applies the bias voltage at a suitable time to ensure that the photodetectors 24 are biased with the bias voltage when a photon is returned from that subsequent shot.

The photodetectors 24 detect returned light from the shots, as described above. The controller 26 is configured, e.g., programmed, to compile a histogram (e.g., that may be used to generate the 3D environmental map) based on detection of returned shots, e.g., detected by the photodetectors 24 and received from the ROICs 40. The histogram indicates an amount and/or frequency at which light is detected from different reflection distances, i.e., having different times of flights. The histograms are generated at blocks 915 of FIG. 9 and example histograms are shown in FIGS. 7A-D. The histograms are time-resolved histograms, as described above.

The controller 26 is programed to identify that the counts in one of the bins of the histogram for a pixel 38 exceed a predetermined level, as shown in decision blocks 920, and reduces the sensitivity for the time range associated with that bin for that pixel 38 for subsequent shots. Exceeding the predetermined level indicates a high return during the time range associated with that bin. In the example shown in FIG. 9, the controller 26 determines whether the counts in a bin exceed a predetermined level, and if so decreases the sensitivity, after every shot. As another example, the controller 26 may determine whether the counts exceed a predetermined level, i.e., employing block 920 followed by block 925, after only periodic groups of shots.

The predetermined level may be different for each pixel 38. Thus, decision block 920 is unique to each pixel 38. Specifically, the controller 26 is initially determining whether the predetermined level, e.g., a first predetermined level, has been exceeded for each bin of each pixel 38. When a bin exceeds the first predetermined level, the controller 26 subsequently determines whether a second predetermined level is exceeded for that bin for that pixel 38. The second predetermined level may be different than the first predetermined level.

In response to the identification that the counts in the one bin of the histogram for the one pixel 38 exceeds the predetermined level, for subsequent shots, the controller 26 is configured, e.g., programmed, to reduce the sensitivity of that pixel 38 during the time range associated with the one bin of the histogram for that pixel 38 to be lower than the sensitivity of that pixel 38 at other time ranges. In other words, the controller 26 reduces the sensitivity of a pixel 38 for the time range associated with the bin that has counts exceeding a predetermined level. As also set forth above, after subsequent shots, the lidar system 20 further reduces the sensitivity of that pixel 38 at that time range when that bin exceeds a second predetermined level. The predetermined level and the second predetermined level are shown in FIGS. 7A-7D merely by way of example, and the lidar system 20 may operate with any suitable number of predetermined levels and a matching number of sensitivity reductions.

As one example, as shown in FIGS. 7A-D, the predetermined levels may be set thresholds. In that example, if the counts in a bin exceed a threshold, the sensitivity of the pixel 38 is reduced at the time range associated with that bin. As another example, the predetermined level(s) may be based on a defined relationship between the number of shots and the number of counts in the bin. In such an example, the subsequent predetermined level may change after each shot. For example, the predetermined level(s) may be based on an equation in which the number of shots and the number of counts in the bin are variables. As another example, the predetermined level(s) may be based on a lookup table based on the number of counts in the bin. The magnitude of the sensitivity reduction may be predetermined, i.e., the sensitivity may be reduced by a predetermined amount or percentage. In such an example, the predetermined amount or percentage may be the same or different for subsequent predetermined levels. As another example, the magnitude of sensitivity reduction may be based on the number of predetermined levels exceeded by number counts in the bin. As another example, the sensitivity reduction and/or the magnitude of sensitivity reduction may a function of an equation in which the number of shots and the number of counts in the bin are variables. In such an example, a predetermined level is exceeded each time the equation results in a sensitivity reduction.

Sensitivity is a characteristic that may be altered to change the probability of detecting light that will result in an addition to a bin of the histogram. A reduction in sensitivity reduces the probability of detecting light that will result in an addition to a bin of the histogram. One example, for reducing the sensitivity of a pixel for a time range may be an adjustment of the reverse-bias voltage applied to the photodetector(s) 24 of the pixel 38 for that time range. In other words, this reduces the gain of the photodetector(s) 24 to decrease the probability of a photon detection. In this context, “gain” is a measure of an ability of a circuit, e.g., the SPAD, to increase power or amplitude of a signal from the input to the output port. By way of example, FIGS. 7A-D show a percentage reduction in the gain. As another example in which the pixel 38 includes more than one photodetector 24, reducing the sensitivity of the pixel 38 for a time range may be accomplished by adding a count to the histogram only in response to light detection by more than one of the photodetectors of the pixel 38 in the time range. In other words, detection by only one of the multiple photodetectors 24 is insufficient to add a count to the histogram in such an example. As another example in which the pixel 38 includes more than one photodetector 24, reducing the sensitivity of the pixel 38 for a time range may be accomplished by disabling some of the photodetectors 24 of that pixel 38 in the time range.

Reference is now made to the example shown in FIGS. 7A-D. FIGS. 7A-7D each have a graph showing the sensitivity applied to one pixel 38 over time and a time-resolved histogram for a single pixel 38. FIGS. 7A-D may look different for different pixels 38 of the array of pixels 38 depending on the level of photon detection and timing of photon detection.

FIG. 7A shows the sensitivity at a constant level over time for the first of the shots. The sensitivity is the same for each of the pixels 38 at the first shot.

The controller 26 is configured to, after identifying that the counts in one of the bins of the histogram for a pixel 38 exceeds a predetermined level, identify that the counts in that bin exceeds a second predetermined level. The controller 26 is configured to, for subsequent shots, in response to the identification that the counts in that bin for that pixel 38 exceeds the second predetermined level, further reduce the gain of that pixel 38 during the time range associated with that bin of the histogram for that pixel 38. For example, as shown in FIG. 7B, the count in bin 8 exceeds a predetermined level and, in response, the lidar system 20 identifies that the sensitivity for that pixel 38 at the time range associated with bin 8 will be reduced for subsequent shots (e.g., the gain is reduced to 50% of the gain for the first of the shots). Next, in FIG. 7C, the counts in bin 8 exceed a second predetermined level. In response, the lidar system 20 identifies that the sensitivity for that pixel 38 at the time range associated with bin 8 will be further reduced for subsequent shots (e.g., the gain is reduced to 25% of the gain for the first of the shots. As set forth above, the controller 26 may be configured to have any suitable number of predetermined levels and corresponding sensitivity reductions of any suitable magnitude that can be implemented after any one or group of shots.

The controller 26 is configured to detect counts that exceed a predetermined level for each bin for each pixel 38. This detection may be made after each shot or after a series of shots. In such an example, multiple pixels 38 may have one or more bins that have counts that exceed a predetermined level, as shown in FIGS. 7A-D. For example, the controller 26 may be configured to identify that the counts in a first bin and counts in a second bin of the histogram for the one of the pixels 38 both exceed their predetermined levels. For subsequent shots, the controller 26 reduces the gain of that pixel 38 during the time range associated with the first bin and during the time range associated with the second bin of the histogram for that pixel 38. In such an example, the bins may be adjacent and/or may be bins or groups of bins that are spaced from each other, both of which are shown in FIGS. 7A-D.

Since the controller 26 is configured to detect the counts that exceed a predetermined level for each bin for each pixel 38, multiple pixels 38 may have one or more bins that have counts that exceed a predetermined level, as shown in FIG. 9. In such an event, the controller 26 is configured to reduce the sensitivity for each pixel 38 at the respective time ranges associated with the bins that have counts exceeding predetermined levels. The sensitivity adjustment for one pixel 38 may be independent of the sensitivity adjustment of the other pixels 38, as shown in FIG. 9.

FIGS. 7B-7D are after additional shots; by way of example, after 500 shots in FIG. 7B, 1000 shots in FIG. 7C, and 2000 shots in FIG. 7D. In FIG. 7B, after 500 shots, the count in bin 8 exceeds a predetermined level and, in response, the lidar system 20 identifies that the sensitivity for that pixel 38 at the time range associated with bin 8 will be reduced for subsequent shots (e.g., the gain is reduced to 50% of the gain for the first of the shots). In FIG. 7C, after 1000 shots, the counts in bin 8 exceed a second predetermined level and the counts in bins 7, 9, and 20 exceed a predetermined level (which, by way of example, is the same as the predetermined level in FIG. 7B). In response, the lidar system 20 identifies that the sensitivity for that pixel 38 at the time range associated with bin 8 will be further reduced for subsequent shots (e.g., the gain is reduced to 25% of the gain for the first of the shots), and the sensitivity for that pixel 38 for the time ranges associated with bin 7, bin 9, and bin 20 will be reduced for subsequent shots (e.g., the gain is reduced to 50% of the gain for the first of the shots). In FIG. 7D, after 2000 shots, the sensitivity at the time range associated with bin 8 remains at the further reduced sensitivity (e.g., at 25% gain) as after 1000 shots in FIG. 7C, and the sensitivity at the time ranges associated with bins 7, 9, 10, and 20 is reduced (e.g., at 50% gain). FIG. 8, as described further below, shows an example of a circuit that can perform the operation shown in FIGS. 7A-7D.

FIG. 8 is an example circuit 60 of a lidar system 20 showing an example photodetector 24 of a pixel 38. The circuit 60 shows an example implementation for adjusting the sensitivity (specifically, gain in this example) of pixels 38 for specific bins based on the counts in the respective bins, as discussed herein with respect to FIGS. 7A-7D and 8.

Example circuit 60 includes the photodetector 24 and a control logic 62 for adjusting the gain of the photodetector 24. The control logic 62 includes an input interface 66 and an output interface 64. The output interface 64 is connected to a control input of the photodetector 24. The output interface 64 outputs a gain control signal, which may be a digital signal or an analog signal, to the photodetector 24. The photodetector 24 may include additional circuit (not shown) to adjust the photodetector 24 gain based on the received gain control signal. In one example, the gain control signal may have 3 levels, 100%, 50%, and 25%. Thus, the gain of the photodetector 24 may be adjusted to be at 100%, 50%, or 25% based on the received digital signal. In yet another example, the gain control value may be an analog value within a specified range, e.g., 25% to 100%.

The control logic 62 may include digital and/or analog components, which implement a logic to determine the gain control signal, which is outputted via the output interface 64 to the photodetector 24. The control logic 62 determines the gain control signal based on data received via the input interface 66 of the control logic 62. The control logic 62 may receive, via the input interface 66, data specifying a bin count of a histogram memory 68 storing the bin counts of received photons. In one example, the control logic 62 may determine (i) a gain control signal of 100% when a bin count is less than a first predetermined level, (ii) a gain control signal of 50% when the bin count is greater than the first predetermined level but less than a second predetermined level, and (iii) determine a gain control signal of 25% when the bin count is greater than the second predetermined level.

The histogram memory 68 has data lines and address lines. Address lines of the histogram memory 68 specify an address in the memory where data may be fetched or written. Data lines transfer data from or to the histogram memory 68. In a memory fetch action, after applying address data through the data lines, the histogram memory 68 outputs stored bin counts via the data lines. In a memory writing action, the histogram memory 68 writes the value represented through the data lines to the memory at the address specified by the address lines.

As shown in FIG. 8, the example circuit 60 may include a counter circuit or alternatively, a microcontroller or the like configured to change the address data applied to the histogram memory 68 in order to repeatedly sweep through various bins of the histogram memory 68.

As discussed above, the control logic 62 outputs the gain control signal to the photodetector 24 determined based on a specific bin count. Thus, prior to receiving photons related to a specific bin, the control logic 62 shall apply the respective gain control signal to the photodetector 24. In one example, the example circuit 60 may include an address adder block, e.g., plus 2, to determine a bin count in advance of receiving photons related to the respective bin. Further, the example circuit 60 may include delay component circuit blocks to add data received for a bin to a respective bin count in the histogram memory 68.

Because the histogram memory 68 holds a histogram, thus needs to add data representing new detected photons to the already stored bin count in the histogram memory 68. In one example, the example circuit 60 may include a data adder block which sums a current bin count stored in the histogram memory 68 and the currently detected photos, thereby updating the histogram memory 68 based on detected photons.

FIG. 9 is a process flow diagram illustrating an exemplary process 900 for controlling the lidar system 20. In FIG. 9, the subscripts after 905 indicate the shot number. The subscripts after 910-925 indicate the shot number and the pixel number. For example, 910₁₋₁ is the application of the bias voltage to a first pixel for a first shot. The variable N may be any suitable number, e.g., thousands of shots and thousands of pixels.

The process 900 begins in a block 905. At the block 905 the controller 26 actuates the light emitter 22 to output a shot of light. The controller 26 may actuate the light emitter 22 by sending one or more commands to the light emitter 22. For the first shot, each of the pixels 38 has the same sensitivity and the sensitivity is constant for all time ranges associated with the histogram.

At block 910, the controller 26 provides a bias voltage to the pixels 38 e.g., by sending a command to the power supply circuits of the respective photodetectors 24. Specifically, for the first shot at block 905₁, the bias voltage may be the same for all pixels 38 and for all time ranges associated with the histogram bins. For subsequent shots, the bias voltage may be different for different pixels 38 and may be different at different time ranges for the same pixel 38, as described herein.

At block 915, the controller 26 updates time-resolved histograms for the pixels 38 based on light detected by the pixels 38. Each histogram has bins associated with time ranges of light detection.

The controller 26 determines whether the counts in any of the bins of the histogram for any pixel 38 exceeds a predetermined level (as described above). At decision blocks 920, the controller 26 identifies that the counts in a bin of the histogram for one of the pixels 38 exceed a predetermined level. If the controller 26 determines that the counts in a bin of the histogram for one of the pixels 38 exceeds a predetermined level, the method 900 moves to block 925 for that pixel 38. At block 925, for subsequent shots, in response to the identification that the counts in one of the bins of the histogram that pixel 38 exceeds the predetermined level, the controller 26 reduces the sensitivity of that pixel 38 during the time range associated with that bin of the histogram for that pixel 38 to be lower than the sensitivity of the one pixel at other time ranges. If the controller 26 determines at block 925 that none of the bins of that pixel 38 have counts that exceed a predetermined level, the controller 26 does not adjust the sensitivity for that pixel 38 for the next shot. Blocks 920 and 925 may be performed for each bin for each pixel 38 at each shot.

As set forth above, at block 925, the controller 26 reduces the sensitivity of that pixel 38 during the time range associated with that bin of the histogram for that pixel 38 to be lower than the sensitivity of that pixel 38 at other time ranges. In other words, in response to the bin that exceeds the predetermined level, the controller 38 reduces the sensitivity for the time range associated with that bin for that pixel 38 for subsequent shots and does not reduce the sensitivity of other time ranges for that pixel 38 (unless another bin has counts that exceed a predetermined level, in which case, the sensitivity of that pixel 38 at the time associated with other bin is reduced as shown in method 900). In the event the sensitivity is reduced for a time range for a pixel 38, the sensitivity remains at that reduced level for that time range for that pixel 38 (or is further reduced if other predetermined levels are exceeded after subsequent shots) until all of the shots are fired. After all shots are fired, at block 930, the controller 26 may reset the sensitivity of the pixels 38. This may include a total reset of all pixels 38 back to the same sensitivity as for the first shot at the beginning of method 900. As another example, the reset may carry over some information to the next round of shots so that some pixels 38 at some time ranges may have reduced sensitivity based on the data from the previous shots, e.g., an area of high photon return.

The method performs blocks 910-925 for each pixel 38 for each shot (e.g., shots 1-M in FIG. 9). Accordingly, the sensitivity may change on a pixel-by-pixel basis and may vary during time ranges for a pixel 38. For example, FIG. 9 shows that after identifying that the counts in one of the bins of the histogram for one of the pixels 38 exceed a predetermined level, the controller 26 again determines whether the counts in that bin of the histogram for that pixel 38 exceeds a predetermined level, e.g., a second predetermined level as described above, for subsequent shots. If the controller 26 identifies that the counts in that bin of the histogram for pixel 38 exceeds the predetermined level, e.g., the second predetermined level, then for subsequent shots, the controller 26 further reduces the sensitivity of that pixel 38 during that time range associated with that bin of the histogram.

As another example, multiple bins in for the same pixel 38 may have counts that exceed a predetermined level. In such an event, the controller 26 reduces the sensitivity for that pixel 38 at the time ranges associated with each of the bins that have counts that exceed the predetermined level. Specifically, in addition to adjusting the sensitivity for a time range associated with a first bin for a pixel 38, the controller 26 may reduce the sensitivity of that pixel 38 during the time range associated with a second bin of the histogram for that pixel 38. As shown in FIGS. 7A-D, some bins for the same pixel 38 may reach predetermined levels at different times, i.e., after different number of shots. In the example shown in FIGS. 7A-D, some of the bins that have counts that exceed the predetermined level are adjacent to each other. This indicates a high signal return. The sensitivity adjustment for one time range may be independent of the sensitivity adjustment of other time range for the pixel 38, as shown in FIG. 9.

As another example, multiple pixels 38 may have one or more bins that have counts that exceed a predetermined level, as shown in FIG. 9. In such an event, the controller 26 reduces the sensitivity for each pixel 38 at the respective time ranges associated with the bins that have counts exceeding predetermined levels. The sensitivity adjustment for one pixel 38 may be independent of the sensitivity adjustment of the other pixels 38, as shown in FIG. 9.

As set forth above, the method includes reducing sensitivity in blocks 925. Reduction in sensitivity may be accomplished as described above.

With regard to the process 900 described herein, it should be understood that, although the steps of such process have been described as occurring according to a certain ordered sequence, such process could be practiced with the described steps performed in an order other than the order described herein. It further should be understood that certain steps could be performed simultaneously, that other steps could be added, or that certain steps described herein could be omitted. In other words, the description of the process herein is provided for the purpose of illustrating certain embodiments and should in no way be construed so as to limit the disclosed subject matter.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

What is claimed is:

1. A lidar system, comprising:
a light emitter;
an array of pixels, each pixel including at least one photodetector; and
a controller configured to:
actuate the light emitter to output shots of light;
for each pixel, update a time-resolved histogram for the shots based on light detected by the pixel, each histogram having bins associated with time ranges of light detection;
identify that the counts in one of the bins of the histogram for one pixel exceed a predetermined level; and
for subsequent shots, in response to the identification that the counts in the one bin of the histogram for the one pixel exceeds the predetermined level, reduce the sensitivity of the one pixel during the time range associated with the one bin of the histogram for the one pixel to be lower than the sensitivity of the one pixel at other time ranges.

2. The lidar system as set forth in claim 1, wherein the controller is configured to:
after identifying that the counts in the one of the bins of the histogram for the one pixel exceed a predetermined level, identify that the counts in the one bin of the histogram for the one pixel exceed a second predetermined level; and
for subsequent shots, in response to the identification that the counts in the one bin of the histogram for the one pixel exceeds the second predetermined level, further reduce the sensitivity of the one pixel during the time range associated with the one bin of the histogram for the one pixel.

3. The lidar system as set forth in claim 2, wherein the controller is configured to:
identify that the counts in a second bin of the histogram for the one pixel exceeds a predetermined level; and
for subsequent shots, in response to the identification that the counts in the second bin of the histogram for the one pixel exceeds the predetermined level, reduce the sensitivity of the first pixel during the time range associated with the second bin of the histogram for the first pixel to be lower than the sensitivity of the first pixel during other time ranges.

4. The lidar system as set forth in claim 3, wherein the predetermined level for one bin is the same as the predetermined level for the second bin.

5. The lidar system as set forth in claim 3, wherein the controller is configured to:
after identifying that the counts in the second bin of the histogram for the one pixel exceed the predetermined level, identify that the counts in the one bin of the histogram for the one pixel exceed a second predetermined level; and
for subsequent shots, in response to the identification that the counts in the second bin of the histogram for the one pixel exceeds the second predetermined level, further reduce the sensitivity of the one pixel during the time range associated with the second bin of the histogram for the one pixel.

6. The lidar system as set forth in claim 3, wherein the one bin and the second bin are adjacent each other.

7. The lidar system as set forth in claim 1, wherein the controller is configured to:
identify that the counts in a second bin of the histogram for the one pixel exceeds a predetermined level; and
for subsequent shots, in response to the identification that the counts in the second bin of the histogram for the one pixel exceeds the predetermined level, reduce the sensitivity of the first pixel during the time range associated with the second bin of the histogram for the first pixel to be lower than the sensitivity of the first pixel during other time ranges.

8. The lidar system as set forth in claim 1, wherein the sensitivity is substantially the same for each of the pixels for a first one of shots.

9. The lidar system as set forth in claim 1, wherein the one pixel includes more than one photodetector, and wherein reducing the sensitivity of the one pixel is further defined as adding a count to the histogram thereafter in response to light detection by more than one of the photodetectors of the one pixel in the time range associated with one of the bins.

10. The lidar system as set forth in claim 1, wherein reducing the sensitivity of the one pixel is further defined as adjusting a reverse-bias voltage to the photodetector.

11. The lidar system as set forth in claim 1, wherein the photodetector is a single-photon avalanche diode.

12. A method comprising:
actuating a light emitter to output shots of light;
updating time-resolved histograms for the pixels based on light detected by the pixels, each histogram having bins associated with time ranges of light detection;
identifying that the counts in one bin of the histogram for one pixel exceed a predetermined level; and
for subsequent shots, in response to the identification that the counts in the one bin of the histogram for the one pixel exceeds the predetermined level, reducing the sensitivity of the one pixel during the time range associated with the one bin of the histogram for the one pixel to be lower than the sensitivity of the one pixel at other time ranges.

13. The method as set forth in claim 12, further comprising:
after identifying that the counts in the one of the bins of the histogram for the one pixel exceed a predetermined level, identifying that the counts in the one bin of the histogram for the one pixel exceed a second predetermined level; and
for subsequent shots, in response to the identification that the counts in the one bin of the histogram for the one pixel exceeds the second predetermined level, further reducing the sensitivity of the one pixel during the time range associated with the one bin of the histogram for the one pixel.

14. The method as set forth in claim 12, further comprising:
identifying that the counts in a second bin of the histogram for the one pixel exceeds a predetermined level; and
for subsequent shots, in response to the identification that the counts in the second bin of the histogram for the one pixel exceeds the predetermined level, reducing the sensitivity of the first pixel during the time range associated with the second bin of the histogram for the first pixel to be lower than the sensitivity of the first pixel during other time ranges.

15. The method as set forth in claim 14, wherein the predetermined level for one bin is the same as the predetermined level for the second bin.

16. The method as set forth in claim 14, further comprising:
after identifying that the counts in the second bin of the histogram for the one pixel exceed the predetermined level, identifying that the counts in the one bin of the histogram for the one pixel exceed a second predetermined level; and
for subsequent shots, in response to the identification that the counts in the second bin of the histogram for the one pixel exceeds the second predetermined level, further reducing the sensitivity of the one pixel during the time range associated with the second bin of the histogram for the one pixel.

17. The method as set forth in claim 14, wherein the one bin and the second bin are adjacent each other.

18. The method as set forth in claim 12 further comprising:
identifying that the counts in a second bin of the histogram for the one pixel exceeds a predetermined level; and
for subsequent shots, in response to the identification that the counts in the second bin of the histogram for the one pixel exceeds the predetermined level, reducing the sensitivity of the first pixel during the time range associated with the second bin of the histogram for the first pixel to be lower than the sensitivity of the first pixel during other time ranges.

19. The method as set forth in claim 12, further comprising applying a bias voltage to the pixels, the bias voltage being substantially the same for each of the pixels for the first one of shots.

20. The method as set forth in claim 12, wherein the one pixel includes more than one photodetector, and wherein reducing the sensitivity of the one pixel is further defined as adding a count to the histogram in response to light detection by more than one of the photodetectors of the one pixel in the time range associated with one of the bins.

21. The method as set forth in claim 12, wherein reducing the sensitivity of the one pixel is further defined as adjusting a reverse-bias voltage to the photodetector.
